(19) United States
(12) Patent Application Publication
(10) Pub. No.: US 2002/0135825 A1
(43) Pub. Date: Sep. 26, 2002

(54) High light-sensing efficiency image sensor apparatus and method

(76) Inventors: Chih-Kung Lee, Taipei (TW); Long-Sun Huang, Taipei (TW); Wen-Jong Chen, Taipei (TW); Ching-Heng Tang, Taipei (TW); Ching-Hua Lee, Tao Yuan County (TW)

Correspondence Address: BAKER & McKENZIE, 12th Floor, 101 West Broadway, San Diego, CA, 92101, US

(21) Appl. No.: 09/904,733

(22) Filed: Jul. 13, 2001

(30) Foreign Application Priority Data
Jul. 15, 2000 (TW) 89114209

(51) Int. Cl. H04N 1/46

(52) U.S. Cl. 358/509

(57) ABSTRACT

An image sensor apparatus for converting an incident light into electric signal is disclosed. The apparatus has a color separation layer that comprises a body layer for receiving incident light. A surface of the body layer is covered by a two-dimensional microlens array of lenslets, and the other surface of the body layer is covered by a blazed diffraction grating layer. A zeroth-order reflection layer is disposed behind the color separation layer along the path of the incident light for reflecting away zeroth-order component of the incident light. An image sensor array is disposed further behind the zeroth-order reflection layer along the path of the incident light and comprises a two-dimensional array of light-sensing cells. Each of the light-sensing cells is disposed at a position aligned with a corresponding one of the lenslets in the microlens array and comprises a red, a green and a blue photoelectric sensor for respectively converting energy of photons of the incident light in the red, green and blue color bands into electric signals proportionally representing the energy level of photons in the corresponding color bands.

### FIELD OF THE INVENTION

This invention relates generally to an image sensor apparatus and, in particular, to an image sensor apparatus with high light-sensing efficiency and the corresponding method of manufacturing the sensor apparatus.

### BACKGROUND OF THE INVENTION

With the rapid development in computer, communication, consumer electronics and multimedia technologies, the market of photoelectronic products incorporating a core image-sensing detector also enjoyed tremendous growth. Among the more familiar photoelectronic products are digital cameras, digital video recorders and scanners, etc. In addition to computer peripherals and communication equipment, these photoelectronic products also find wide-spread use in areas such as security, medical, military, space and aeronautical applications.

Currently, many of the photoelectronic products for imaging applications incorporate the use of sensors based on the Charged-Coupled Device (CCD) technology. Complementary Metal-Oxide-Semiconductor (CMOS) image sensors are finding more applications due to its relatively lower cost. Part of the reason for some preference toward CCD sensors is due to the earlier development of the CCD, which is now a more matured technology.

With the introduction of new CMOS imaging components, more and more new photoelectronic products have adopted CMOS sensor devices for imaging applications. Intel Corp., for example, announced plans to use CMOS technology for its future digital camera products. Because the supporting peripheral circuitry of a CMOS sensor array can be manufactured on the same silicon wafer for the array detector, a very high level of integration can be achieved. Complexity of a photoelectronic system can be greatly reduced, which also lowers production costs. Miniaturization of a system can be achieved more easily. However, despite these advantages of CMOS imaging devices, CCD arrays still offer better performance for high-fidelity imaging applications.

In order to better illustrate the advantages of the image sensor apparatus and its method of manufacturing of the present invention, the structural configuration of a typical prior-art image sensor is examined first. FIG. 1 is a cross-sectional view schematically illustrating the structural configuration of a conventional image sensor device. The cross-sectional view is taken along the direction of an incident light in a plane perpendicular to the surface of the array detector.

As is illustrated in the drawing, a conventional image sensing device 100 has a number of light sensor cells, constructed either of CCD or CMOS technology, and arranged in a two-dimensional image sensor array 110. Above the surface 112 of the image sensor array 110 that receives the incident light is a two-dimensional primary color filter array 120. The filter array 120 includes red filters 122, green filters 124 and blue filters 126. Note that only a small portion of the system, one of each of the three primary color filters, is shown in FIG. 1. Further above, there is normally a protective transparent layer 130 placed on top of the color filter array 120. This protective layer may, for example, be a glass optical window.

When obtaining an image, the incident light 140 propagates first through a lens set (not shown in the drawing) disposed before the transparent layer 130. Next, the incident light 140 passes through the transparent layer 130, filtered by the filter array 120, and finally reaches to the image sensor array 110. Function of the filter array 120 is to isolate the photons of the three primary colors of the incident light to be detected by the light sensor cells of the image sensor array 110 utilizing its red, green and blue filters 122, 124 and 126 respectively.

In conventional image sensor devices such as that examined in FIG. 1, the alternating arrangement of red, green and blue filters in the primary color filter array allows filtering of the incident light carrying an image to be sensed. In the process, most of the photons of the incident light are discarded and, in a sense, wasted. Approximately only 30% of the photons of the incident radiation are converted into electrical signal.

Because of the low efficiency, quality of the sensed image is severely degraded due to Poison noise in the photon detection process. Due to the deficiency of the conventional image sensing devices, there is a need for a high light-sensing efficiency image sensor apparatus with improved quality of sensed images for photoelectronic equipment.

### SUMMARY OF THE INVENTION

It is therefore an object of the present invention to provide an image sensor apparatus that operates with high light-sensing efficiency.

It is another object of the present invention to provide a method of manufacturing an image sensor apparatus that provides high light-sensing efficiency and is low in production costs.

In order to achieve the above-identified objects, the present invention provides an image sensor apparatus for converting an incident light into electric signal that has a color separation layer and comprises a body layer for receiving incident light. A surface of the body layer is covered by a two-dimensional microlens array of lenslets, and the other surface of the body layer is covered by a blazed diffraction grating layer. A zeroth-order reflection layer is disposed behind the color separation layer along the path of the incident light for reflecting away zeroth-order component of the incident light. An image sensor array is disposed further behind the zeroth-order reflection layer along the path of the incident light and comprises a two-dimensional array of light-sensing cells. Each of the light-sensing cells is disposed at a position aligned with a corresponding one of the lenslets in the microlens array and comprises a red, a green and a blue photoelectric sensor for respectively converting energy of photons of the incident light in the red, green and blue color bands into electric signals proportionally representing the energy level of photons in the corresponding color bands.

The invention further provides a method for fabricating an image sensor apparatus for converting an incident light into electric signal comprising the steps of: (a) constructing a color separation layer utilizing a transparent optical material, the color separation layer comprising a body layer for receiving the incident light, a surface of the body layer being covered by a two-dimensional microlens array of lenslets, and the other surface of the body layer being covered by a blazed diffraction grating layer; (b) constructing a zeroth-order reflection layer utilizing a transparent optical material, the zeroth-order reflection layer being disposed behind the color separation layer along the path of the incident light for reflecting away zeroth-order component of the incident light; and (c) constructing an image sensor array utilizing a transparent optical material, the image sensor array being disposed behind the zeroth-order reflection layer along the path of the incident light and comprising a plurality of light-sensing cells arranged in a two-dimensional array; each of the light-sensing cells being disposed at a position aligned with a corresponding one of the lenslets in the microlens array and comprising a red, a green and a blue photoelectric sensor for respectively converting energy of photons of the incident light in the red, green and blue color bands into electric signals proportionally representing the energy level of photons in the corresponding color bands.

### BRIEF DESCRIPTION OF THE DRAWINGS

In the following paragraphs, design configuration of an image sensor apparatus and its corresponding method of manufacture in accordance with preferred embodiments of the present invention will be described with reference to the accompanying drawings in which

FIG. 1 is a cross-sectional view schematically illustrating the component structural configuration of a prior-art image sensor device;

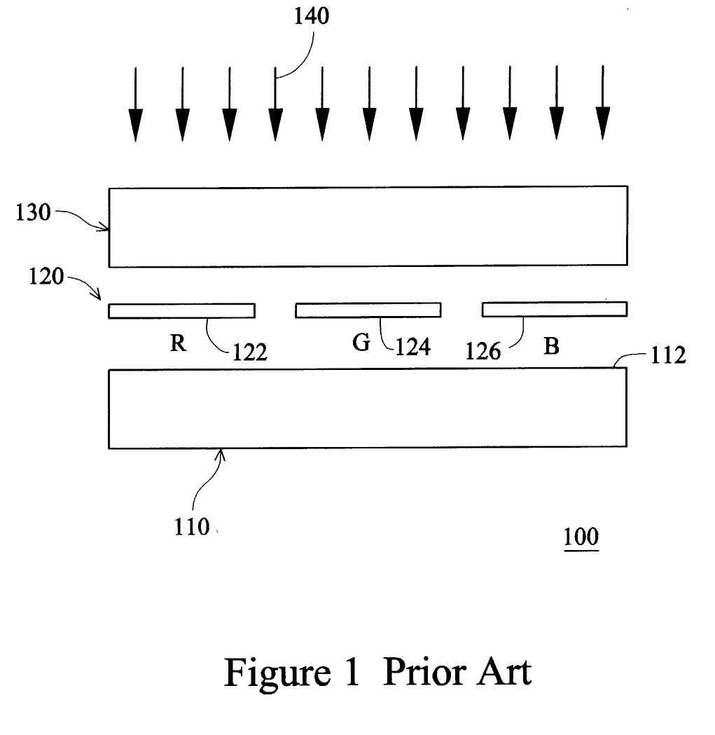

FIG. 2 is a cross-sectional view schematically illustrating the component structural configuration of an image sensor apparatus in accordance with a preferred embodiment of the present invention;

FIG. 3 is a perspective view of the image sensor apparatus of the preferred embodiment of FIG. 2 illustrating the lenslets in the microlens array of the color separation layer and the light sensor cells of the image sensor array;

FIG. 4 is a perspective view illustrating the structural configuration of the blazed diffraction grating of the image sensor apparatus of the preferred embodiment of FIG. 2; and

FIG. 5 illustrates the optical path in an image sensor apparatus in accordance with the preferred embodiment of the present invention.

### Detailed Description of the Invention

In an image sensor apparatus in accordance with the present invention, quality of sensed images can be improved while the system cost reduced simultaneously. This is achieved, in general, by enhancement of the overall light transmission efficiency of the system, an increase of the number of photons reaching to the light sensing cells of the image sensor array.

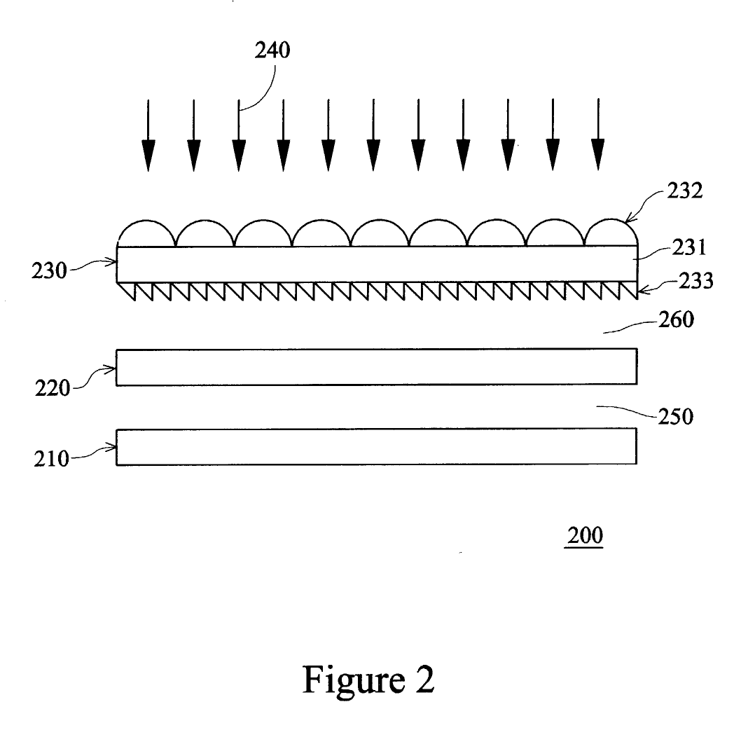

FIG. 2 is a cross-sectional view schematically illustrating the component structural configuration of an image sensor apparatus 200 in accordance with a preferred embodiment of the present invention. The cross section is taken along a selected plane parallel to the direction of the incident light and perpendicular to the surface of the image sensor apparatus.

As is comprehensible, a lens set not shown in the drawing may be disposed in front of the image sensor apparatus 200 of the present invention. Such a lens set may be used to focus the image onto the apparatus 200. The incident light propagates downward along the path identified by reference numeral 240, passing through the lens set—if one is installed—to be received by the image sensor apparatus 200.

As is shown in the drawing, the image sensor apparatus 200 in accordance with a preferred embodiment of the present invention comprises an image sensor array 210, a zeroth-order light reflection layer 220, and a color separation layer 230. Upper surface of the image sensor array 210, to be illuminated by the incident light 240, is covered by the zeroth-order reflection layer 220. The color separation layer 230 is in turn placed above the zeroth-order reflection layer 220.

Note that in the embodiment of the image sensor apparatus 200 of FIG. 2, there is a space 250 between the image sensor array 210 and the zeroth-order light reflection layer 220. Also, there is a space 260 between the zeroth-order light reflection layer 220 and the color separation layer 230. These spaces 250 and 260 can be vacuum spaces, or they may be filled with any applicable gas or dielectric material. Note that the space 250 can be eliminated completely. For example, in an arrangement, the image sensor array 210 and the zeroth-order light reflection layer 220 can be placed right against each other.

The image sensor array 210 of the apparatus 200 of FIG. 2 is comprised of a two-dimensional array of a number of light sensor cells, which are not seen in the schematic illustration. The image sensor array 210 can be an array of light sensor cells based on CCD, CMOS, or any other type of photoelectric sensor technology that is capable of converting photons into electrical signal. In other words, the image sensor array 210 for the apparatus 200 can either be a CCD sensor array, a CMOS sensor array, or other types of photoelectric detector array.

In the depicted embodiment of FIG. 2, the color separation layer 230 has a body layer 231. One side of the body layer facing the incident light, i.e. the upper side in the drawing, has a two-dimensional microlens array 232. On the other hand, the opposite, i.e. the lower, side of the body layer 231 has a blazed diffraction grating 233.

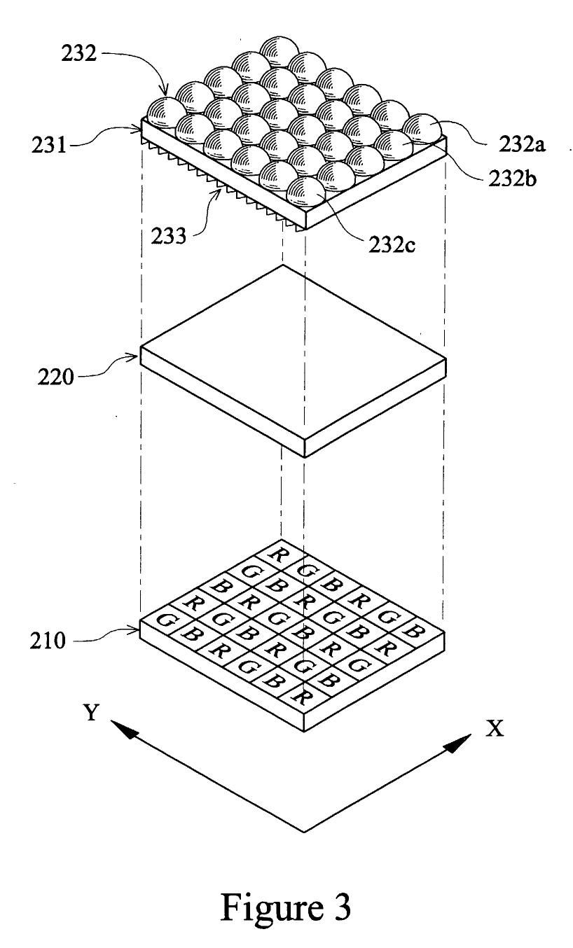

FIG. 3 is a perspective view of the image sensor apparatus of the preferred embodiment of FIG. 2. FIG. 3 lays out the lenslets in the microlens array 232 of the color separation layer 230 and the light sensor cells of the image sensor array 210. In the drawing, the distances between the image sensor array 210, the zeroth-order reflection layer 220 and the color separation layer 230 are not illustrated to the exact scale. The stretched distances along the direction of the path of the incident light are in order to show details of each of the component layers.

As is seen in FIG. 3, each of the lenslets, including those identified as 232a, 232b and 232c, of the two-dimensional microlens array 232 of the color separation layer 230 has a spherical surface. They are laid out with regular intervals in the X and Y direction to form a two-dimensional array. In a similar manner, the three color pixels, identified as pixels R, G and B respectively, of each unit of the light sensor cells are also laid out alternately at regular intervals in the X and Y directions to form a two-dimensional array.

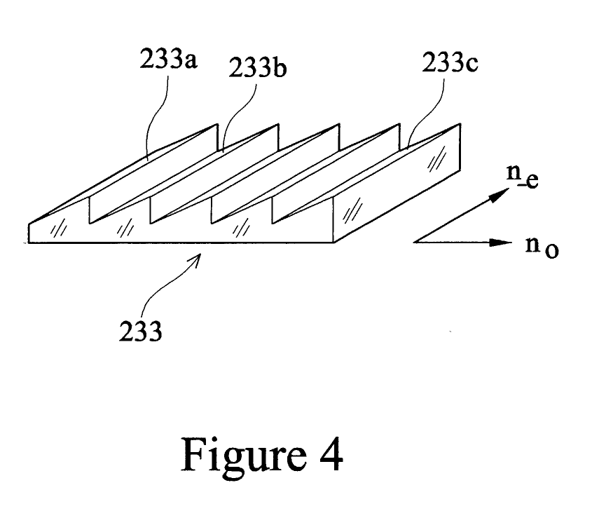

FIG. 4 is a perspective view illustrating the structural configuration of the blazed diffraction grating 233 of the image sensor apparatus 200 of the preferred embodiment of FIG. 2. As is illustrated, the blazed grating 233 in general has a periodic one-dimensional structure. Each of the grating elements, including those identified as 233a, 233b and 233c, has a non-symmetrical triangular cross section and extends in the direction nₑ that is perpendicular to the repeating direction nₒ of the periodic structure. Each of the grating elements of the grating 233 protrudes from the underside of the body layer 231 of the color separation layer 230, as is illustrated in FIGS. 2 and 3.

For the color separation layer 230 (FIGS. 2 and 3), the relative position of the blazed grating 233 and the microlens array 232 with respect to the body layer 231 is not important. For example, the microlens array 232 and the blazed grating 233 can be located on the same side of the body layer 231. Such change in configuration does not change the sensitivity of the apparatus. However, because of the difference in the characteristics of the respective surface structures of these three layers, it may not be possible to provide a smooth interface between some combinations of two of the layers. An air gap or dielectric-filled layer may be needed for interfacing these structural layers.

The operating principle of the image sensor apparatus 200 of the present invention is that incident light is first focused by the microlens array 232 of the color separation layer 230 and then the effect of light diffraction in the blazed grating 233 separates the colors. The zeroth-order component of the diffracted light is then reflected away such that it does not reach to the image sensor array 210. The dispersed light that is transmitted through the zeroth-order reflection layer is then projected into the red, green and blue pixels of the image sensor array 210.

Layout of sensor cells for the three primary colors on the image sensor array 210, after been dispersed by the color separation layer 230 and transmitted through the zeroth-order reflection layer 220, is illustrated in FIG. 3. On each row in the X direction of the image sensor array 210, the three colors are repeated periodically, forming a linear array with a pattern of repeating R, G, B, R, G, B, R . . . and so on. Arrangement of the color pixels in the Y direction follows in a similar periodic pattern.

In order to achieve clean separation of the colors, the spatial frequency of the slits of the blazed grating 233 of the color separation layer 230 must be larger than the spatial frequency of the lenslets in the two-dimensional microlens array 232. Or, in other words, the pitch between the slits of the blazed grating 233 must be smaller than the distance between two consecutive lenslets of the microlens array 232. This arrangement minimizes the interference between the colors. Also, the two surfaces of each of the slit should be formed in a non-symmetric manner in terms of their respective slopes in order to maximize the efficiency of grating.

Surface of the blazed transmission grating 233 can be covered with an antireflection coating. This ensures to filter out the overlapping wavelength between the red, green and blue bands and, as a result, increases the contrast between the three colors. In addition, the bandwidth of the filtered light is very narrow which, substantially, does not reduce the intensity of lights in the three bands of interest. Surface of the two-dimensional microlens array 232 may also be coated with antireflection coating in order to increase the percentage of the light entering into the color separation layer 230 and, subsequently, into the final image sensor array 210.

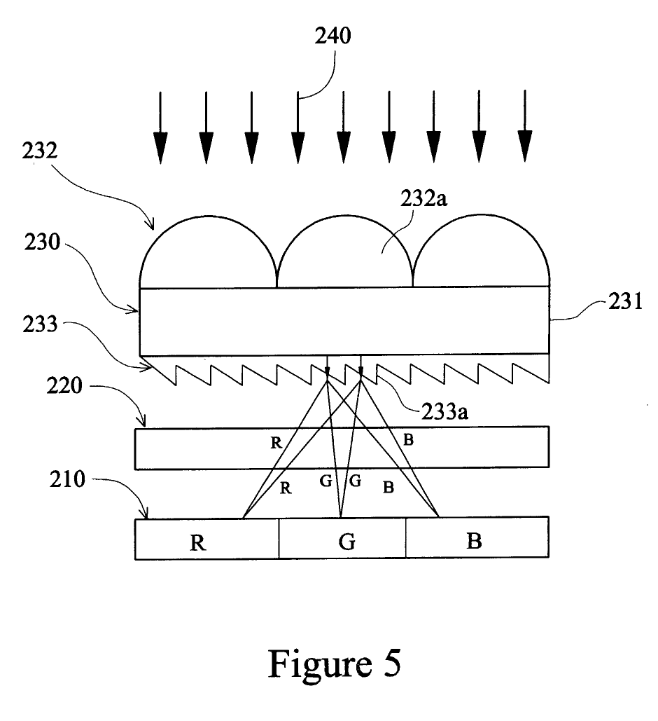

FIG. 5 illustrates the optical path in an image sensor apparatus in accordance with the preferred embodiment of the present invention. A ray of the incident light 240 illuminating the two-dimensional microlens array 232 is first focused by a lenslet 232a, and then passes through the slit 233a of the blazed grating 233.

After the incident light 240 passes through the microlens array 232 and the blazed grating 233 of the color separation layer 230, it is dispersed into three primary colors R, G and B due to the diffraction of light by the grating. The dispersed light then reaches to the zeroth-order reflection layer, which allows the first-order diffracted light to pass through and focuses on the image sensor array 210. Function of the image sensor array 210 is to convert the photons of the three primary colors into electronic signals.

Refer to FIGS. 3 and 5. In order to prevent the zeroth-order component of the light diffracted by the blazed grating 233 of the color separation layer 230 from reaching to the image sensor array 210, it is necessary to insert a zeroth-order reflection layer 220 into the space between the color separation layer 230 and the image sensor array 210. This layer 220 reflects the zeroth-order component of the light, and allows the dispersed first-order component to be transmitted through and focuses on the image sensor array 210 and thereby preventing the interference between the light components.

Blazed grating 233 makes use of the phenomena of light diffraction and interference so as to achieve the separation of colors. Periodic placement of the slits of the grating causes lights of different wavelengths in the incident light to exit the grating at different angles, pass through the zeroth-order reflection layer 220, and reach to the image sensor array 210. Thus, the image sensor apparatus 200 of the present invention does not require the use of filters for separating primary colors of the incident light. Light loss due to absorption by the filters is therefore prevented.

Moreover, usually a blazed grating has a very high light transmission efficiency, and lights with different wavelengths can be directed to the desired position on the image sensor array 210 through the zeroth-order reflection layer 220. Such design of the apparatus of the present invention thus ensures that color pixels of the image sensor array 210 may be able to receive the possible maximum amount of energy, and the overall light-sensing efficiency of the apparatus is thus enhanced greatly.

In practical implementations of the image sensor apparatus of the present invention, the color separation layer 230 can be realized using a transparent optical material for the construction of the two-dimensional microlens array 232, the blazed grating 233, and the body layer 231. An integrated color separation layer 230 may be constructed. For example, in one preferred embodiment, the color separation layer 230 can be constructed from a solid piece of optical glass, plastics, or other suitable optical materials utilizing appropriate manufacturing techniques for the respective material selected.

In another preferred embodiment, in order to achieve high efficiency of light transmission and also to accommodate the requirements of the manufacturing process, different materials can be used for the different component layers of the color separation layer 230. For example, the body layer 231 can be constructed using optical glass or PMMA. Materials including PMMA and others such as certain photoresists and ARTON (Norbornene) can be used for the construction of the microlens array 232 and the blazed grating 233.

Techniques that may be employed to construct the required structures of the two-dimensional array 232 and the blazed grating 233 of the color separation layer 230 include chemical etching procedures similar to those used in the fabrication of semiconductor devices. Traditional machining processes, excimer laser machining, and/or MEMS (Micro-Electro-Mechanical Systems) technology are also suitable. Of course, low-cost mass production can also be realized by producing replica from a master color separation unit utilizing molding technique.

Meanwhile, conventional semiconductor packaging technologies for making hermetically sealed semiconductor devices, such as CLCC (Ceramic Leadless Chip Carrier), PLCC (Plastic Leadless Chip Carrier), QFP (Quad Flat Pack), QFN (Quad Fine-pitch No-lead) and QFJ (Quad Flat J-lead) may be utilized to pack the fabricated image sensor apparatus of the present invention as a hermetically sealed device. All these facilitate easy integration of the image sensor apparatus of the present invention with other photoelectronics components and products.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An image sensor apparatus for converting an incident light into electric signal, said apparatus comprising:
a color separation layer comprising a body layer for receiving said incident light, a surface of said body layer being covered by a two-dimensional microlens array of a plurality of lenslets, and the other surface of said body layer being covered by a blazed diffraction grating layer;
a zeroth-order reflection layer disposed behind said color separation layer along the path of said incident light for reflecting away zeroth-order component of said incident light; and
an image sensor array disposed behind said zeroth-order reflection layer along the path of said incident light and comprising a plurality of light-sensing cells arranged in a two-dimensional array; each of said light-sensing cells being disposed at a position aligned with a corresponding one of said lenslets in said microlens array and comprising a red, a green and a blue photoelectric sensor for respectively converting energy of photons of said incident light in the red, green and blue color bands into electric signals proportionally representing the energy level of photons in the corresponding color bands.

2. The image sensor apparatus of claim 1, wherein said blazed diffraction grating layer comprises a plurality of slits, said slits having a periodicity larger than the periodicity of said lenslet of said microlens array.

3. The image sensor apparatus of claim 1, wherein each of said slits has a non-symmetric configuration of two inclined surfaces.

4. The image sensor apparatus of claim 1, wherein said zeroth-order reflection layer is disposed in front of said image sensor array along the path of said incident light and has no spacing therebetween.

5. The image sensor apparatus of claim 1, wherein said zeroth-order reflection layer is disposed in front of said image sensor array along the path of said incident light and has a vacuum space therebetween.

6. The image sensor apparatus of claim 1, wherein said zeroth-order reflection layer is disposed in front of said image sensor array along the path of said incident light and has a gas-filled space therebetween.

7. The image sensor apparatus of claim 1, wherein said zeroth-order reflection layer is disposed in front of said image sensor array along the path of said incident light and has a transparent dielectric medium-filled space therebetween.

8. The image sensor apparatus of claim 1, wherein said image sensor apparatus is sealed in a CLCC package.

9. The image sensor apparatus of claim 1, wherein said image sensor apparatus is sealed in a PLCC package.

10. The image sensor apparatus of claim 1, wherein said image sensor apparatus is sealed in a QFP package.

11. The image sensor apparatus of claim 1, wherein said image sensor apparatus is sealed in a QFN package.

12. The image sensor apparatus of claim 1, wherein said image sensor apparatus is sealed in a QFJ package.

13. A method for fabricating an image sensor apparatus for converting an incident light in to electric signal, said method comprising the steps of:
(a) constructing a color separation layer utilizing a transparent optical material, said color separation layer comprising a body layer for receiving said incident light, a surface of said body layer being covered by a two-dimensional microlens array of lenslets, and the other surface of said body layer being covered by a blazed diffraction grating layer;
(b) constructing a zeroth-order reflection layer utilizing a transparent optical material, said zeroth-order reflection layer being disposed behind said color separation layer along the path of said incident light for reflecting away zeroth-order component of said incident light; and
(c) constructing an image sensor array utilizing a transparent optical material, said image sensor array being disposed behind said zeroth-order reflection layer along the path of said incident light and comprising a plurality of light-sensing cells arranged in a two-dimensional array; each of said light-sensing cells being disposed at a position aligned with a corresponding one of said lenslets in said microlens array and comprising a red, a green and a blue photoelectric sensor for respectively converting energy of photons of said incident light in the red, green and blue color bands into electric signals proportionally representing the energy level of photons in the corresponding color bands.

14. The method for fabricating an image sensor apparatus of claim 13, wherein said transparent optical material is optical glass.

15. The method for fabricating an image sensor apparatus of claim 13, wherein said transparent optical material is optical plastics.

16. The method for fabricating an image sensor apparatus of claim 13, wherein said transparent optical material used for constructing said microlens array is PMMA.

17. The method for fabricating an image sensor apparatus of claim 13, wherein said transparent optical material used for constructing said blazed grating is PMMA.

18. The method for fabricating an image sensor apparatus of claim 13, wherein said transparent optical material used for constructing said microlens array is photoresist.

19. The method for fabricating an image sensor apparatus of claim 13, wherein said transparent optical material used for constructing said blazed grating is photoresist.

20. The method for fabricating an image sensor apparatus of claim 13, wherein said transparent optical material used for constructing said microlens array is ARTON.

21. The method for fabricating an image sensor apparatus of claim 13, wherein said transparent optical material used for constructing said blazed grating is ARTON.

22. The method for fabricating an image sensor apparatus of claim 13, wherein said color separation layer is constructed utilizing chemical etching procedures.

23. The method for fabricating an image sensor apparatus of claim 13, wherein said color separation layer is constructed utilizing excimer laser machining procedures.

24. The method for fabricating an image sensor apparatus of claim 13, wherein said color separation layer is constructed utilizing Micro-Electro-Mechanical System procedures.
